(19) United States
(12) Patent Application Publication
(10) Pub. No.: US 2025/0174620 A1
(43) Pub. Date: May 29, 2025

(54) FLUIDIZATION APPARATUS AND BATTERY MANUFACTURING SYSTEM INCLUDING THE SAME

(71) Applicants: HYUNDAI MOTOR COMPANY, SEOUL (KR); KIA CORPORATION, SEOUL (KR)

(72) Inventors: Hyun Jin Kim, Daegu (KR); Han Nah Song, Suwon-si (KR)

(21) Appl. No.: 18/640,632

(22) Filed: Apr. 19, 2024

(30) Foreign Application Priority Data
Nov. 24, 2023 (KR) 10-2023-0164998

(51) Int. Cl. H01M 4/04; B05C 19/06

(52) U.S. Cl. CPC H01M 4/0402; B05C 19/06; H01M 4/0435

(57) ABSTRACT

The manufacturing of a dry electrode includes the use of a fluidization apparatus. The fluidization apparatus is configured to mix a supplied dry electrode mixture with a fluid in order to fluidize the dry electrode mixture and to supply the fluidized dry electrode mixture to a film-making apparatus. The fluidization apparatus includes a chamber formed in a housing, the chamber being configured to receive the dry electrode mixture, an inlet configured to allow a fluid to enter the chamber, and an outlet configured to allow the fluid in the chamber to be discharged therethrough.

### CROSS REFERENCE TO RELATED APPLICATIONS

This application claims, under 35 U.S.C. § 119 (a), the benefit of priority to Korean Patent Application No. 10-2023-0164998, filed on Nov. 24, 2023, the entire contents of which are incorporated herein by reference.

### TECHNICAL FIELD

The present disclosure relates to the manufacture of a dry electrode.

### BACKGROUND

In recent years, rechargeable secondary batteries have been expanding their applications to various fields, from small electronic devices to large energy storage systems. In particular, the rapid growth of the electric vehicle market has led to active research and development on secondary batteries.

Each electrode of a secondary battery has traditionally been manufactured using a wet process. In the wet process, a slurry is manufactured by dissolving an electrode active material, a binder, and a conductive agent included in the electrode with a solvent. In recent years, however, a dry process has received a lot of attention because the dry process can increase energy density of the battery compared to the wet process without using the solvent required in the wet process.

In the dry process, a dry electrode film is formed by mixing an electrode active material, a conductive agent, and a binder into a mixture without solvent and forming the mixture as a film by pressing or calendaring. The formed dry electrode film may be bonded to a current collector, whereby an electrode may be manufactured.

In the dry electrode manufacturing process, no solvent is used, whereby it is possible to reduce manufacturing time and cost, and the film thickness may be controlled, whereby it is possible to obtain a dry electrode film with high energy density, compared with the wet electrode manufacturing process.

Due to the nature of the dry electrode mixture in a powder state, however, accelerated high-speed film making for mass production of dry electrodes is difficult.

The above information disclosed in this Background section is provided only for enhancement of understanding of the background of the disclosure and therefore it may contain information that does not form the prior art that is already known to a person of ordinary skill in the art.

### SUMMARY

The present disclosure has been made in an effort to solve the above-described problems associated with the prior art.

It is an object of the present disclosure to provide a fluidization apparatus capable of facilitating feeding of a dry electrode mixture to a film-making roll during film making and a feeding system including the same.

It is another object of the present disclosure to provide a fluidization apparatus capable of improving the quality of a dry electrode formed as a film and performing a film-making process at high speed and a feeding system including the same.

It is another object of the present disclosure to provide a battery manufacturing system including the fluidization apparatus and a battery including a dry electrode manufactured using the fluidization apparatus.

It is a further object of the present disclosure to provide a battery manufacturing method including a process of fluidizing a dry electrode mixture.

The objects of the present disclosure are not limited to that described above. The objects of the present disclosure will be clearly understood from the following description of embodiments and could be implemented by means defined in the claims and a combination thereof.

Features of the present disclosure to accomplish the above objects and to perform the following characteristic functions are as follows.

In one aspect, a fluidization apparatus is configured to mix a supplied dry electrode mixture with a fluid in order to fluidize the dry electrode mixture and to supply the fluidized dry electrode mixture to a film-making apparatus. The fluidization apparatus includes a chamber formed in a housing, the chamber being configured to receive the dry electrode mixture, an inlet configured to allow a fluid to enter the chamber, and an outlet configured to allow the fluid in the chamber to be discharged therethrough.

In another aspect, a feeding system includes a feeding apparatus configured to store a dry electrode mixture and a fluidization apparatus configured to receive a dry electrode mixture from the feeding apparatus and to mix the dry electrode mixture with a fluid in order to fluidize the dry electrode mixture.

In a further aspect, a battery manufacturing method includes mixing an electrode active material, a conductive agent, and a binder using a mixer to manufacture a dry electrode mixture, mixing the manufactured dry electrode mixture with a fluid using a fluidization apparatus to fluidize the dry electrode mixture, and forming the fluidized dry electrode mixture as a dry electrode film using a roll press.

Other aspects and preferred embodiments of the disclosure are discussed infra.

### BRIEF DESCRIPTION OF THE FIGURES

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a view schematically showing a process of manufacturing a dry electrode;

FIG. 2 shows a feeding zone of a dry electrode mixture during the manufacture of the dry electrode;

FIG. 3 shows a bridge formed in a hopper during the feeding of the dry electrode mixture;

FIG. 4 shows a fluidization apparatus of a feeding system according to the present disclosure;

FIG. 5 shows the discharge of the dry electrode mixture from the fluidization apparatus of FIG. 4;

FIG. 6 is a side view of a fluidization apparatus according to an embodiment of the present disclosure;

FIGS. 7 and 8 are perspective views of the fluidization apparatus according to the embodiment of the present disclosure;

FIG. 9 is a perspective view showing a lid open state of the fluidization apparatus according to the embodiment of the present disclosure,

FIGS. 10 and 11 are perspective views of the fluidization apparatus according to the embodiment of the present disclosure; and

FIG. 12 shows the feeding system according to the embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

Specific structural or functional descriptions of the embodiments of the present disclosure disclosed in this specification are given only for illustrating embodiments of the present disclosure. Embodiments of the present disclosure may be implemented in various forms. In addition, the embodiments according to the concept of the present disclosure are not limited to such specific embodiments, and it should be understood that the present disclosure includes all alterations, equivalents, and substitutes that fall within the idea and technical scope of the present disclosure.

It will be understood that, although the terms “first,” “second,” etc., may be used herein to describe various elements, corresponding elements should not be understood as being limited by these terms, which are used only to distinguish one element from another. For example, within the scope defined by the present disclosure, a first element may be referred to as a second element, and similarly, a second element may be referred to as a first element.

It will be understood that, when a component is referred to as being “connected to” or “coupled to” another component, it may be directly connected to or coupled to the other component, or intervening components may be present. In contrast, when a component is referred to as being “directly connected to” or “directly coupled to” another component, there are no intervening components present. Other terms that describe the relationship between components, such as “between” and “directly between” or “adjacent to” and “directly adjacent to”, must be interpreted in the same manner.

Wherever possible, the same reference numbers will be used throughout the drawings to refer to the same or like parts. The terms used in this specification are provided only to explain specific embodiments, but are not intended to restrict the present disclosure. A singular representation may include a plural representation unless it represents a definitely different meaning from the context. It will be further understood that the terms “comprises”, “comprising” and the like, when used in this specification, specify the presence of stated components, steps, operations, and/or elements, but do not preclude the presence or addition of one or more other components, steps, operations, and/or elements.

Hereinafter, the present disclosure will be described in detail with reference to the accompanying drawings.

A dry electrode may be manufactured from a dry electrode mixture and a current collector without a solvent. The dry electrode mixture M is a mixture including an electrode active material, a conductive agent (conductive additive or conductive material), and a binder. The dry electrode mixture M may further include an additive.

The dry electrode may be a cathode or an anode. In some implementations, when a cathode is manufactured, the electrode active material includes a cathode active material. As a non-limiting example, the cathode active material may include LCO(LiCoO₂), NCM(Li(Ni,Co,Mn)O₂), NCA(Li(Ni,Co,Al)O₂), LMO(LiMnO₄), LFP(LiFePO₄), or sulfur.

In some implementations, when an anode is manufactured, the electrode active material includes an anode active material. For example, the anode active material may include natural graphite, artificial graphite, mesocarbon microbeads (MCMBs), or a silicon-based material.

The conductive agent may include a carbon-based material. For example, the conductive agent may include carbon black, acetylene black, carbon fiber, or carbon nanotubes.

The binder may include a polymer-based chemical, such as polyvinylidene fluoride (PVDF), polyvinyl alcohol (PVA), polytetrafluoroethylene (PTFE), styrene-butadiene rubber (SBR), carboxymethyl cellulose (CMC), or polyacrylonitrile (PAN).

A solid polymer electrolyte, such as poly(ethylene oxide) (PEO), or oxide- or sulfide-based solid electrolyte may be partially used as the additive.

The dry electrode mixture may include 70 to 99.9 wt % of the electrode active material, 0.1 to 20 wt % of the conductive agent, and 0.1 to 20 wt % of the binder. 0 to 20 wt % of the additive may be added thereto.

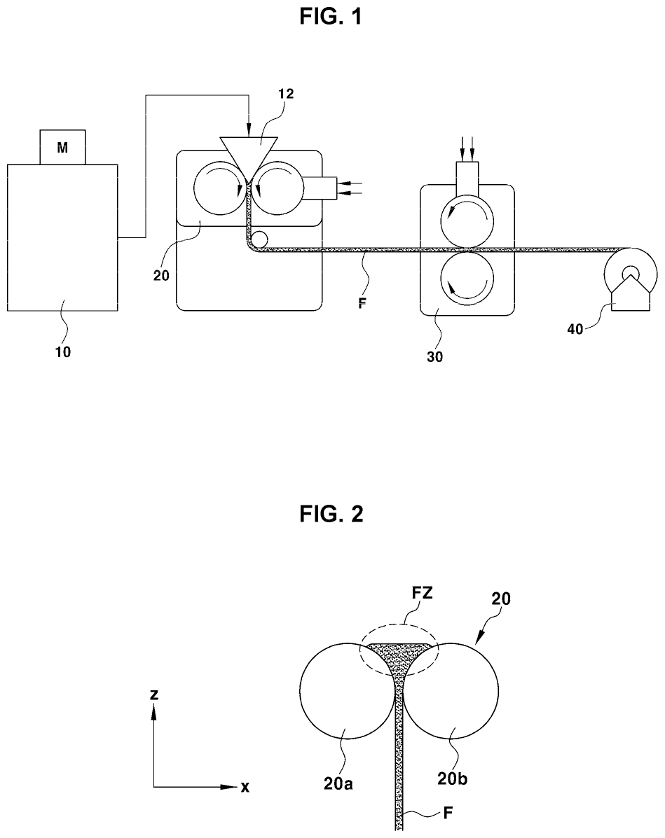

As shown in FIG. 1, the dry electrode mixture M is manufactured as a dry electrode film F through a series of film-making processes under heat and pressure. First, the dry electrode mixture M including the electrode active material, the conductive agent, and the binder is mixed by a mixer 10 at a predetermined speed for a predetermined time. As a non-limiting example, the dry electrode mixture may be manufactured through a high shear mixer using rotation or a fluidity mixer using air, and the predetermined time and speed may be adjusted by varying the rotational speed and run time of the mixer 10. As another non-limiting example, the dry electrode mixture may be manufactured using a compactor, a granulator, or a combination thereof.

The mixed dry electrode mixture M may be first pressed by an upstream roll press 20 to be formed as a film. The upstream roll press 20 rotates while providing pressing force to form the dry electrode mixture M as a film. The dry electrode mixture M primarily formed as the film may be further pressed by a downstream roll press 30, and the thickness thereof may be adjusted by pressing. The dry electrode mixture formed as the film, i.e., the dry electrode film F, is wound by a winder 40. Subsequently, the dry electrode film F may be bonded or laminated to a current collector to manufacture a dry electrode. Manufacture of the dry electrode film and lamination thereof on the current collector may be performed in one apparatus or may be performed in separate apparatuses.

In the process of manufacturing the dry electrode, mixing of the dry electrode mixture M may be performed using the mixer 10. In some implementations, the electrode active material and conductive agent may be dispersed, and the binder may be introduced, whereby the dry electrode mixture M may be dispersed, in the mixing process. In some implementations, the electrode active material, the conductive agent, and the binder may be introduced, and the dry electrode mixture M may be dispersed.

In some implementations, the mixer 10 may be a spiral mixer, a vertical mixer, a horizontal mixer, an oblique mixer, a planetary mixer, a paddle mixer, a screw mixer, a stand mixer, a granulator, a jet mill, or a compactor. In some implementations, mixing may be performed using two or more mixers selected from thereamong. However, the mixer 10 is not limited to these examples.

As a mixing condition, a temperature between −20 and 200 degrees Celsius may be used. In some implementations, the mixer 10 may further include a chiller to ensure that a low temperature state is maintained during mixing.

When the binder in the materials has acquired sufficient energy through mixing to become fibrous, the fibrous binder may connect the active material, the conductive agent, and the additive in the form of a network, whereby the mixing process may be completed.

After mixing is completed, the dry electrode mixture M is transported to the next step for film making. The transport of the dry electrode mixture M may be accomplished by a crane, a bogie, a conveyor, a vacuum device, or the like, as needed. The transported dry electrode mixture M may be stored in a hopper and supplied into the roll press via a feeder. For example, the feeder may be a screw feeder, a chain conveyor feeder, a belt feeder, a brush feeder, or a circle feeder.

In manufacturing the dry electrode, the feeding technique of the dry electrode mixture M supplied between rolls of the upstream roll press 20 is very important. Rather than the dry electrode mixture M being accumulated between the rolls 20a and 20b of the upstream roll press 20 to be formed as a film, the fed dry electrode mixture M must be immediately introduced between the rolls 20a and 20b to be formed as a film in order to achieve improvement in quality of the dry electrode and high speed manufacturing of the dry electrode. However, due to the nature of the dry electrode mixture M, which exhibits high agglomeration and low flowability, the technique of uniformly moving the dry electrode mixture between the rolls 20a and 20b is very difficult.

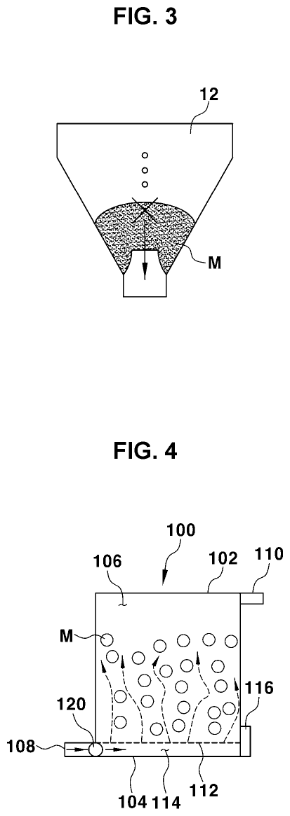

In FIG. 2, there is shown a feeding zone FZ, which is provided between the rolls 20a and 20b of the upstream roll press 20 and into which the dry electrode mixture M is supplied (in FIG. 2, x denotes a horizontal direction and y denotes a vertical direction). When the dry electrode mixture M is introduced between the rolls 20a and 20b while the dry electrode mixture M is accumulated in the feeding zone FZ, a large amount of powder may be simultaneously introduced, whereby the manufactured dry electrode film F may become thicker. Furthermore, if the rotational speed of the rolls 20a and 20b is increased, the quality of the dry electrode film F may be deteriorated.

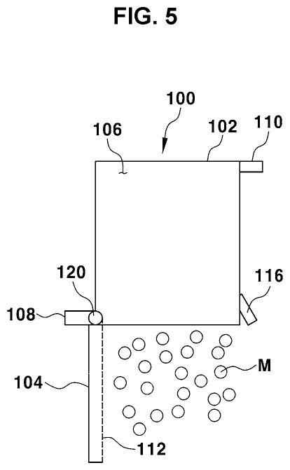

In addition, referring to FIG. 3, since the dry electrode mixture M is characterized by high agglomeration, when the rolls 20a and 20b are rotated while the dry electrode mixture is accumulated in the feeding zone FZ, the pressure caused by the accumulated state may form a bridge, whereby the supply of the dry electrode mixture M may be interrupted. In addition, the dry electrode mixture M may agglomerate even in the state in which the dry electrode mixture is accumulated in the hopper before feeding, whereby a bridge may be formed.

Due to the high agglomeration and low flowability of the dry electrode mixture M, there are problems, such as agglomeration of the dry electrode mixture M in a tube and blockage of the tube, even when the dry electrode mixture is transported through the tube.

Accordingly, the present disclosure provides a dry electrode mixture feeding system that can address problems caused by high agglomeration and low flowability of the dry electrode mixture by mixing the dry electrode mixture M with a fluid to move the dry electrode mixture M like a liquid or gas, using fluidization. Also, the present disclosure provides a method of manufacturing a dry electrode for batteries through a manufacturing process using the feeding system, and a dry electrode manufactured thereby.

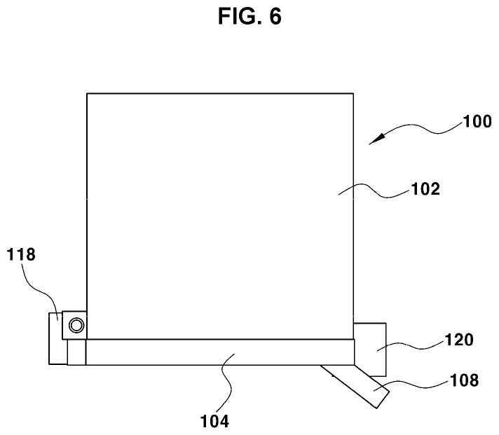

As shown in FIG. 4, a fluidization apparatus 100 according to the present disclosure may mix a dry electrode mixture M supplied thereto with a fluid, such as air, to fluidize the dry electrode mixture. In the fluidized state, the dry electrode mixture M does not exhibit high agglomeration and low flowability.

In an embodiment, the dry electrode mixture M introduced into the fluidization apparatus 100 is in a state in which particles are complexed. The state in which the particles are complexed refers to a state in which the components constituting the dry electrode mixture M are blended to some extent. That is, if the components of the dry electrode mixture M, i.e., the electrode active material, the conductive agent, and the binder, are simply mixed, they may be separated from each other by the density difference. One the other hand, the state in which the particles are complexed refers to a state in which the conductive agent and the binder are attached to the surface of the electrode active material.

The fluidization apparatus 100 may be disposed upstream of the upstream roll press 20. The dry electrode mixture M, agglomeration of which has been remedied by the fluidization apparatus 100, may be introduced into the upstream roll press 20 directly or via the feeder.

In an implementation of the present disclosure, the fluidization apparatus 100 includes a housing 102 and an openable lid 104. The shape of the housing 102 of the apparatus 100 is not limited but preferably extends vertically without an angle. In some implementations, a packing member may be disposed between the housing 102 and the lid 104. The packing member may prevent possible wear at the interface between the housing 102 and the lid 104 and may prevent gas leakage from the interior.

A chamber 106 is formed in the housing 102. In the chamber 106, the dry electrode mixture M and a fluid may be mixed. In particular, the chamber 106 may have a vertical structure. The vertical chamber 106 may prevent the bridge phenomenon described above. The dry electrode mixture M may be supplied above the housing 102.

The chamber 106 includes an inlet 108 and an outlet 110. A fluid may be supplied into the chamber 106 via the inlet 108, and fluid in the chamber 106 may be discharged via the outlet 110. For example, the fluid may be air. As another non-limiting example, the fluid may be unreactive gas or inert gas. As another non-limiting example, nitrogen (N₂) may be used as the fluid. As a further non-limiting example, when the electrode material includes a solid electrolyte, the fluid may be argon gas.

The fluid introduced into housing 102 via the inlet 108 is supplied to a plenum 114 which is a space in the lid 104. The fluid stays in the plenum 114 for a moment before passing through a distribution plate 112 disposed between the lid 104 and the housing 102. In particular, the distribution plate 112 may be disposed at the lid 104. The distribution plate 112 may be disposed at the interface between the lid 104 and the housing 102. The fluid supplied to the plenum 114 may diverge while passing through the distribution plate 112 and may be introduced into the chamber 106. The fluid introduced into the chamber 106 may be mixed with the dry electrode mixture M while flowing through the dry electrode mixture M, and any remaining fluid may be discharged out of the chamber 106 through the outlet 110.

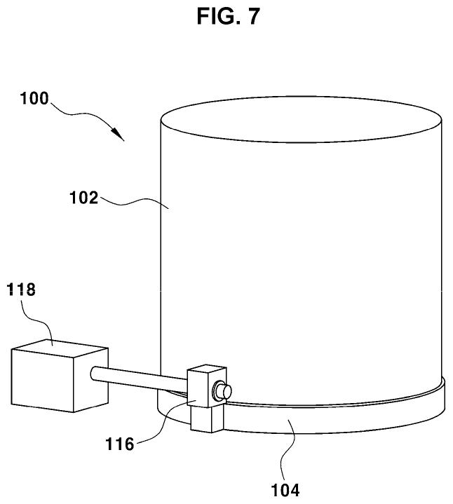

As shown in FIG. 5, the lid 104 is configured to be openable. After the dry electrode mixture M is fluidized, the lid 104 is opened to allow the fluidized dry electrode mixture M to be supplied to a feeding apparatus 260 or the upstream roll press 20.

The lid 104 may be opened at a predetermined point in time. For example, the lid 104 may be opened upon determining that fluidization of the dry electrode mixture M has been completed after a predetermined time has elapsed.

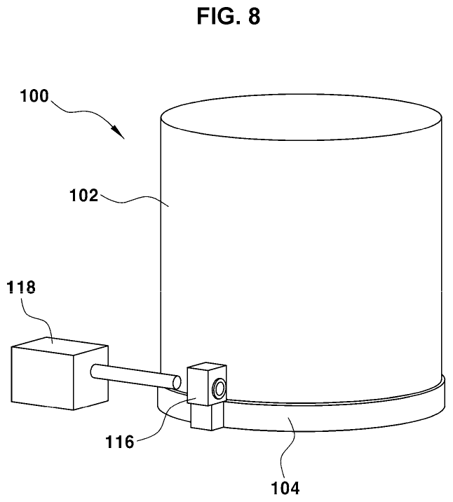

Referring to FIGS. 6 to 9, to this end, according to an implementation of the present disclosure, the fluidization apparatus 100 may be provided with a clamp 116 configured to fix the housing 102 and the lid 104 to each other. A cylinder 118 may be connected to the clamp 116 to unlock the clamp 116. As a non-limiting example, an electric cylinder, a hydraulic cylinder, or a pneumatic cylinder may be used as the cylinder 118.

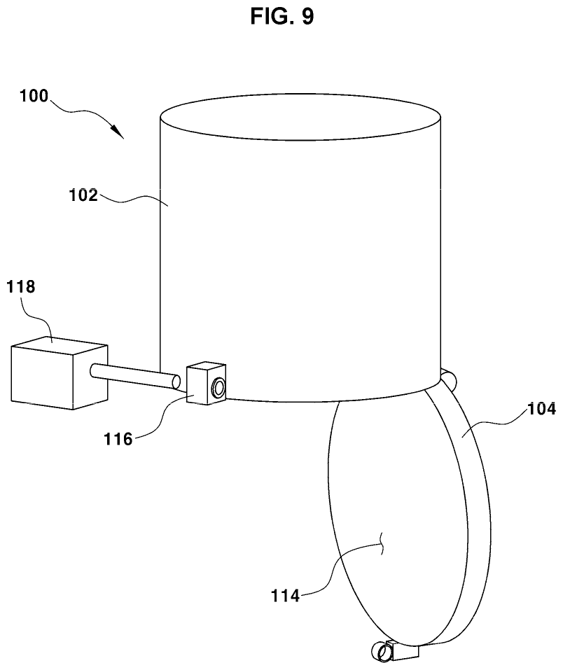

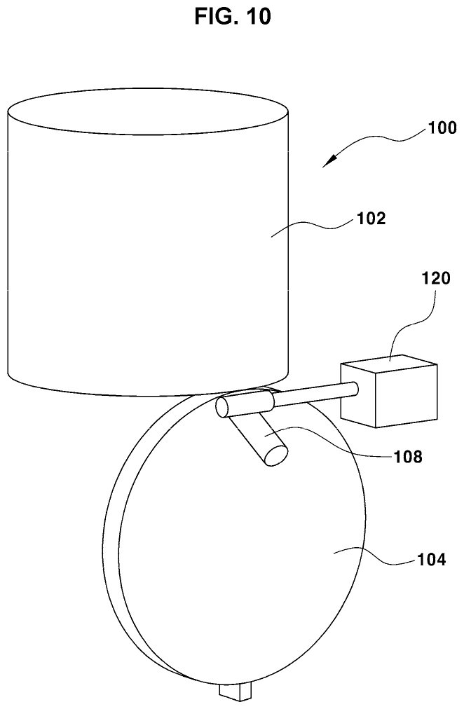

The clamp 116, which was in a locked state as shown in FIG. 7 during operation of the fluidization apparatus 100, may be unlocked as shown in FIG. 8 by operation of the cylinder 118 after completion of fluidization. When the clamp 116 is unlocked, as shown in FIG. 9, the lid 104 may be completely opened due to the weight of the lid 104. The chamber 106 closed by the housing 102 and the lid 104 may communicate with the outside through the lid 104. Opening of the lid 104 is achieved without resistance from the motor 120 with no current supplied to the motor 120. Since no current is supplied to the motor 120 at this time, the lid 104 may be opened about 90° to less than 120°.

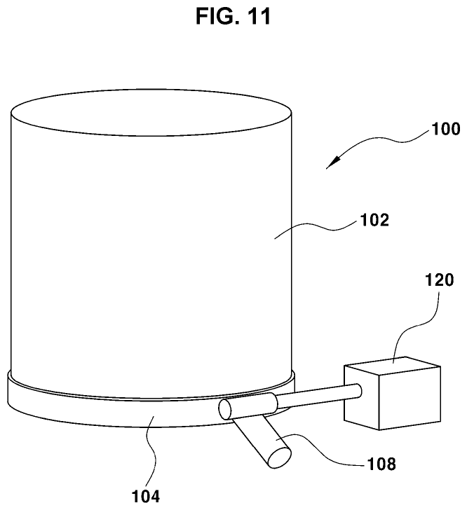

Referring to FIGS. 10 and 11, in an implementation, closing of lid 104 may be achieved through operation of motor 120. When the motor 120 is operated, the lid 104 is rotated upward. In an implementation, the cylinder 118 may be operated when a position sensor provided at the clamp 116 detects the original position of the lid. The cylinder 118 can switch the clamp 116 into a locked state while moving forward.

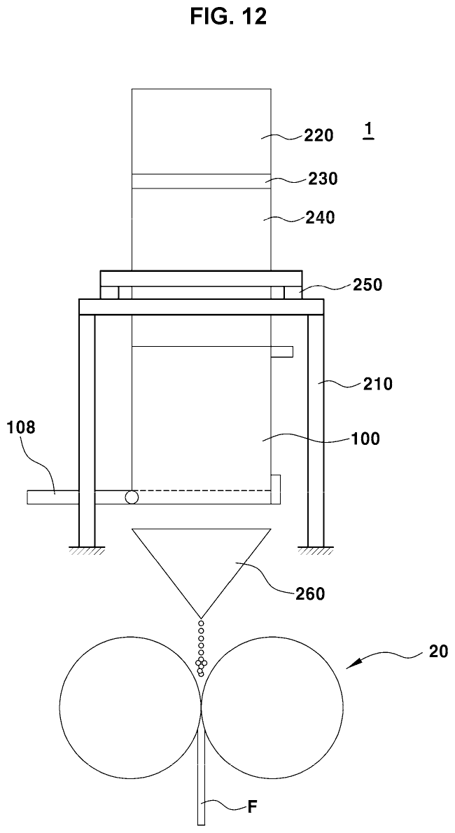

As shown in FIG. 12, a feeding system 200 according to the present disclosure may include a fluidization apparatus 100. The feeding system 200 may further include an upstream hopper 220, a metering feeder 230, and a downstream hopper 240 disposed at a frame 210.

The dry electrode mixture M transported from the mixer 10 is stored in the upstream hopper 220. A predetermined amount of the stored dry electrode mixture M is supplied to the downstream hopper 240 via a metering feeder 230. When the amount of the dry electrode mixture M supplied to the downstream hopper 240 reaches a predetermined amount, the operation of the metering feeder 230 is stopped. In an implementation, the downstream hopper 240 may include a load cell 250 configured to measure the weight of the supplied dry electrode mixture M. Based on the weight measured by the load cell 250, the operation of the metering feeder 230 may be stopped.

A predetermined amount of the dry electrode mixture M supplied into the downstream hopper 240 may be supplied into the fluidization apparatus 100. Supply of the predetermined amount of the dry electrode mixture M into the fluidization apparatus 100 is intended to control the amount of a fluid to be supplied to the fluidization apparatus 100. The amount of air required by the fluidization apparatus 100 is dependent on the amount of the dry electrode mixture M. When the predetermined amount of the dry electrode mixture M is supplied, therefore, the amount of air and the dry electrode mixture M to be fluidized in the fluidization apparatus 100 may be adjusted to be uniform.

The dry electrode mixture M fluidized through the fluidization apparatus 100 may be directly introduced into the upstream roll press 20 or may be introduced into the upstream roll press 20 via a separate feeding apparatus 260. After passing through the upstream roll press 20, the dry electrode film F may be further pressed and laminated to be manufactured as a dry electrode, and ultimately as a battery, as described with reference to FIG. 1.

According to the present disclosure, a plurality of fluidization apparatuses 100 may be used. For example, two or more fluidization apparatuses 100 may be disposed in parallel such that the fluidized dry electrode mixture M can be continuously used for film making during a high-speed process. Since a temporal gap occurs during fluidization of the dry electrode mixture M in one fluidization apparatus 100, the dry electrode mixture M fluidized through the other parallel disposed fluidization apparatus 100 may be used for film making.

According to the present disclosure, it is possible to provide a fluidization apparatus capable of preventing problems in the feeding zone caused by high agglomeration and low flowability of the dry electrode mixture and a feeding system including the same.

The feeding system according to the present disclosure enables the use of a plurality of feeding apparatuses that cannot be used due to the nature of powder and enables high speed film making and quality control.

While it has been described above that the fluidization apparatus according to the present disclosure is used to form the dry electrode mixture as a film, the fluidization apparatus may also be used for other materials that exhibit high agglomeration and low flowability and that need to be formed into films, in addition to the dry electrode mixture.

As is apparent from the foregoing, according to the present disclosure, there is provided a fluidization apparatus capable of facilitating feeding of a dry electrode mixture to a film-making roll during film making and a feeding system including the same.

According to the present disclosure, there is provided a fluidization apparatus capable of improving the quality of a dry electrode formed as a film and performing a film-making process at high speed and a feeding system including the same.

According to the present disclosure, there is provided a battery manufacturing system including the fluidization apparatus.

According to the present disclosure, there is provided a battery manufacturing method including a fluidization process.

The effects of the present disclosure are not limited to the effects mentioned above. It is to be understood that the effects of the present disclosure include all effects that can be deduced from the above description.

It will be apparent to a person of ordinary skill in the art that the present disclosure described above is not limited to the above embodiments and the accompanying drawings and that various substitutions, modifications, and variations can be made without departing from the technical idea of the present disclosure.

1. A fluidization apparatus configured to mix a supplied dry electrode mixture with a fluid in order to fluidize the dry electrode mixture and to supply the fluidized dry electrode mixture to a film-making apparatus, the fluidization apparatus comprising:
a chamber formed in a housing, the chamber being configured to receive the dry electrode mixture;
an inlet configured to allow a fluid to enter the chamber; and
an outlet configured to allow the fluid in the chamber to be discharged therethrough.

2. The fluidization apparatus according to claim 1, further comprising:
a lid connected to the housing, the lid being configured to open the housing; and
a distribution plate positioned between the housing and the lid.

3. The fluidization apparatus according to claim 2, further comprising:
a clamp provided at the apparatus, the clamp being configured to lock the lid and housing to each other; and
a cylinder provided at the apparatus, the cylinder being configured to unlock the clamp.

4. The fluidization apparatus according to claim 3, further comprising a motor configured to rotate the lid.

5. The fluidization apparatus according to claim 1, wherein the housing extends vertically from the lid.

6. The fluidization apparatus according to claim 1, wherein the fluid comprises any one of air, argon gas, nitrogen, unreactive gas, and an inert gas.

7. A battery manufacturing system comprising:
a feeding apparatus configured to store a dry electrode mixture; and
a fluidization apparatus configured to receive a dry electrode mixture from the feeding apparatus and to mix the dry electrode mixture with a fluid to fluidize the dry electrode mixture.

8. The system according to claim 7, wherein the feeding apparatus comprises a metering feeder configured to supply a predetermined amount of the dry electrode mixture to the fluidization apparatus.

9. The system according to claim 7, wherein the feeding apparatus comprises:
an upstream hopper configured to store the dry electrode mixture;
a metering feeder configured to discharge the dry electrode mixture from the upstream hopper;
a downstream hopper configured to receive the dry electrode mixture from the metering feeder; and
a load cell configured to weigh the dry electrode mixture supplied to the downstream hopper.

10. The system according to claim 9, wherein
the fluidization apparatus comprises a chamber configured to receive a predetermined amount of the dry electrode mixture, and
the chamber comprises an inlet and an outlet configured to allow a fluid to pass therethrough.

11. The system according to claim 7, further comprising a roll press comprising a feeding zone configured to receive the fluidized dry electrode mixture, the roll press being configured to press the fluidized dry electrode mixture into a film.

12. The system according to claim 11, further comprising a second feeding apparatus positioned between the roll press and the fluidization apparatus.

13. The system according to claim 7, wherein the dry electrode mixture is a solvent-free mixture of an electrode active material, a conductive agent, and a binder.

14. The system according to claim 7, further comprising:
a mixer configured to mix an electrode active material, a conductive agent, and a binder to manufacture the dry electrode mixture; and
a roll press configured to form the dry electrode mixture fluidized by the fluidization apparatus into a film.

15. A battery manufacturing method, comprising:
mixing an electrode active material, a conductive agent, and a binder using a mixer to manufacture a dry electrode mixture;
mixing the manufactured dry electrode mixture with a fluid using a fluidization apparatus to fluidize the dry electrode mixture; and
forming the fluidized dry electrode mixture as a dry electrode film using a roll press.

16. The method according to claim 15, further comprising laminating the dry electrode film to a current collector.

17. The method according to claim 15, wherein the fluidization apparatus comprises:
a chamber formed in a housing, the chamber being configured to receive the dry electrode mixture;
an inlet configured to allow a fluid to be enter the chamber therethrough; and
an outlet configured to allow the fluid in the chamber to be discharged therethrough.
